(19) United States
(12) Patent Application Publication
(10) Pub. No.: US 2013/0000384 A1
(43) Pub. Date: Jan. 3, 2013

(54) MEASUREMENT SENSOR FOR MOLD INSIDE INFORMATION

(76) Inventors: Masahiro Yamaguchi, Tokyo (JP); Yutaka Iwamoto, Tokyo (JP)

(21) Appl. No.: 13/635,373

(22) PCT Filed: Mar. 18, 2011
(86) PCT No.: PCT/JP2011/056658

§ 371 Date: Sep. 14, 2012

(30) Foreign Application Priority Data
Mar. 18, 2010 (JP) 2010-088160

(51) Int. Cl. G01N 7/00; G01N 25/00

(52) U.S. Cl. 73/25.01; 73/31.04

(57) ABSTRACT

Gas pressure in a cavity is detected with a rod-shaped casing that attaches to an hole that opens into the cavity. A porous filter whose top end face matches with a mold cavity face at a top end of the rod-shaped casing separates gas from melt. Cavity gas from an introduction chamber introduces gas through the porous filter, and a gas pressure sensor detects pressure in the chamber. Melt pressure in the cavity is detected with a pressure transmission rod inserted into the rod-shaped casing whose top end face matches with the mold cavity face, and a pressure sensor fixed and held facing a rear end of the pressure transmission rod detects the cavity melt pressure. Cavity melt temperature is detected with a temperature sensor attached to a thin hole formed at the pressure transmission rod's center and includes a thermocouple at a top end part side of the hole.

### TECHNICAL FIELD

The present invention relates to a measurement sensor for mold inside information which is suitable for determining quality of casting products or resin molding products as detecting pressure of melt in a mold of a die-cast machine for pressure-casting of metallic material such as aluminum alloy and magnesium or melt in a mold for resin molding, gas pressure, and melt temperature.

### BACKGROUND ART

It has been known that quality of die-cast products is influenced by injection speed and injection pressure when filling metal melt into a mold. In an injection process to fill metal melt into a mold of a die-cast machine, to prevent air entrapment into the metal melt and the like, metal melt is supplied to a plunger sleeve and a plunger is moved frontward as being driven at low injection speed until the plunger sleeve and a product runner portion are filled up. Subsequently, when the plunger is moved to a position reaching where a top end of the metal melt reaches a gate, the metal melt is rapidly filled into the mold cavity with driving of the plunger to be switched to high injection speed. Subsequently, when the metal melt is filled into the mold cavity, the metal melt is pressurized by increasing pressure of the plunger.

As illustrated in FIG. 8, a mold used for a die-cast machine is structured with a movable die 1a and a fixed die 1b. A cavity 2 formed by both of the dies 1a, 1b is provided with a sprue 3a, a runner 3b and a gate 3c connected to an injection cylinder, and further, with an air vent 4 for draining gas in the cavity 2 and an overflow 5.

FIG. 9 is a sectional view illustrating a state that metal melt is filled into the cavity 2 of a mold in a die-cast machine. In this drawing, a predetermined amount of metal melt ML is supplied through a pouring port 6a of the plunger sleeve 6 with a ladle. This drawing illustrates an injecting state while a plunger 7 is driven at low speed from a state that the predetermined amount of metal melt ML is supplied into the plunger sleeve 6. In a slow-speed injecting state, gas G exists along with the metal melt ML at the front side of a plunger tip 7a and gas G exists also at the runner 3b which introduces the metal melt ML in the plunger sleeve 6 to the cavity 2. Further, a position FP indicated in FIG. 9 denotes a point at which the plunger 7 is switched from low-speed movement to high-speed movement. When the plunger tip 7a reaches the position FP, the metal melt ML is filled into the plunger sleeve 6 and the runner 3b and a top end part of the metal melt ML reaches the gate 3c. That is, the position FP is a filling start position at which filling of the metal melt ML into the cavity 2 is started.

FIG. 10 is a view indicating variation waveforms of injection speed J of the plunger 7, injection pressure K, metal pressure L, gas pressure M and metal temperature T at the time of injection molding in chronological order along a time axis. In this drawing, the injection pressure is approximately at a constant value while the plunger 7 is moved at high injection speed. Subsequently, filling pressure is rapidly increased and maintained thereat owing to pressure rising. In contrast, the metal pressure hardly rises while the plunger 7 is moved at high injection speed. The metal pressure rises approximately to machine pressure when the cavity 2 is filled up with the metal melt ML, and then, starts to drop along with solidification of metal melt at the gate 3c.

By the way, there occur oxide films at metal melt and solidification films when filling into a plunger sleeve. When solidification films, oxide films and the like crushed in injection operation are caught at an inlet gate section during filling while the metal melt ML reaches the gate 3c, supplying of melt is discontinued. As illustrated in FIG. 10, the metal pressure of the metal melt to the cavity 2 is not raised to be in a state of lacking at a midpoint like a curved line B or a curved line C without reaching a normal metal pressure curved line A. Owing to non-pressurization, a molded product is to be a defective in which many air bubbles remain therein.

Approximately 95% of die-cast products are manufactured by cold-chamber die-cast machines with aluminum-based material. However, mechanical properties (tensile strength, extension) are not indicated in Japanese Industrial Standard (JIS). A main reason of the above is that there is a problem of difficulty to evaluate mechanical properties on a quality basis. When melt is poured into a cold chamber and solidification films and oxide films crushed in injection operation are caught at an inlet gate section, there is a high possibility of manufacturing porous products having a large number of blowholes at the inside thereof even with the same external appearance as non-defective products owing to disconnection of melt supply and non-transmission of pressure. Mechanical properties of such porous products are extremely worsened.

Since a plurality of air vents is formed in the mold cavity, it is extremely difficult to measure a gas flow amount as attaching gas flow meters to all of the air vents and to control product quality with the measured gas flow amount. Alternatively, there is a method to detect gas pressure from an air vent. However, stable detection cannot be performed owing to adhering of casting fins to an air vent. In addition, there is gas discharged from mating faces of cores, so that the detection cannot be performed.

There has been known a technology to reduce quality variation caused by gas contained in a die-cast product as suppressing gas to be contained in the die-cast product with casting of a vacuum die-casting method (e.g., see Patent Literature 1). However, in this case as well, measurement of vacuum has been difficult.

### CITATION LIST

### Patent Literature

Patent Literature 1: Japanese Patent Application Laid-Open No. 8-332558

### SUMMARY OF INVENTION

### Technical Problem

Traditionally, although quality management of die-casting has been controlled based on data from a die-cast machine side, controlling of information from a mold has been hardly performed. Although pressure in a mold cavity is increased with incomplete discharging of gas in the mold cavity, there has been a problem of an increased reject rate on a quality basis as being influenced by gas entrapment and the like into a die-cast product.

Further, in a case that cooling water remains in a mold or exudes with mold cracking, explosion occurs in the mold at the moment of contacting of melt with moisture. However, any information cannot be obtained from the mold.

If it is possible to determine whether or not a die-cast product has sufficient strength for each shot of casting, defectives are prevented from being fed to a subsequent process and yield can be improved consequently. Accordingly, in a case of manufacturing die-cast products as injecting metal melt such as melted aluminum alloy or the like into a cavity which is formed in a mold by using a die-cast machine, it is required to measure metal melt pressure and metal melt temperature in the mold during injection and gas pressure of gas in the cavity compressed by filling of metal melt. Here, it is important for manufacturing with stable quality to reliably perform discharging of gas in the cavity.

Such necessity to detect pressure and temperature of metal and pressure of gas in a die-cast machine is the same as in a case of resin molding with a mold.

The present invention has an object to provide a measurement sensor for mold inside information being suitable for performing quality determination of pressure-casting products which are obtained by casting or molding while melt such as metal or resin fed into a plunger sleeve by a specified amount is pressurized and filled into a mold cavity by a plunger.

### Solution to Problem

In order to achieve the object, according to the present invention, a measurement sensor for mold inside information capable of detecting gas pressure in a cavity, includes: a rod-shaped casing which is capable of being attached to an attachment hole formed at a mold and opened to the cavity; a porous filter of which top end face is capable of being matched with a mold cavity face as being arranged at a top end of the rod-shaped casing and which is capable of separating gas from melt; an introduction chamber of cavity gas introduced through the porous filter as being arranged behind the porous filter; and a gas pressure sensor which detects pressure of the gas introduction, chamber.

According to the present invention, a measurement sensor for mold inside information capable of detecting gas pressure in a cavity and melt pressure in the cavity, includes: a rod-shaped casing which is capable of being attached to an attachment hole formed at a mold and opened to the cavity; a porous filter of which top end face is capable of being matched with a mold cavity face as being arranged at a top end of the rod-shaped casing and which is capable of separating gas from melt; an introduction chamber of cavity gas introduced through the porous filter as being arranged behind the porous filter; a gas pressure sensor which detects pressure of the gas introduction chamber; a pressure transmission rod which is inserted into the rod-shaped casing and of which top end face is capable of being matched with the mold cavity face as being movable in the axial center direction; and a pressure sensor which is fixed and held as being faced to a rear end of the pressure transmission rod and which is capable of detecting pressure of melt filled into the cavity.

Further, a measurement sensor for mold inside information capable of detecting gas pressure in a cavity and melt temperature in the cavity, includes: a rod-shaped casing which is capable of being attached to an attachment hole formed at a mold and opened to the cavity; a porous filter of which top end face is capable of being matched with a mold cavity face as being arranged at a top end of the rod-shaped casing and which is capable of separating gas from melt; an introduction chamber of cavity gas introduced through the porous filter as being arranged behind the porous filter; a gas pressure sensor which detects pressure of the gas introduction chamber; a rod which is inserted into the rod-shaped casing and of which top end face is capable of being matched with the mold cavity face as being movable in the axial center direction; and a temperature sensor which is attached to a thin hole formed at a center part of the rod and which includes a thermocouple having a detection end at a rod top end part side of the thin hole.

Further, according to the present invention, a measurement sensor for mold inside information capable of detecting gas pressure in a cavity, melt pressure in the cavity and melt temperature in the cavity, includes: a rod-shaped casing which is capable of being attached to an attachment hole formed at a mold and opened to the cavity; a porous filter of which top end face is capable of being matched with a mold cavity face as being arranged at a top end of the rod-shaped casing and which is capable of separating gas from melt; an introduction chamber of cavity gas introduced through the porous filter as being arranged behind the porous filter; a gas pressure sensor which detects pressure of the gas introduction chamber; a pressure transmission rod which is inserted into the rod-shaped casing and of which top end face is capable of being matched with the mold cavity face as being movable in the axial center direction; a pressure sensor which is fixed and held as being faced to a rear end of the pressure transmission rod and which is capable of detecting pressure of melt filled into the cavity; and a temperature sensor which is attached to a thin hole formed at a center part of the pressure transmission rod and which includes a thermocouple having a detection end at a rod top end part side of the thin hole.

In addition to the configuration above, the measurement sensor for mold inside information may include a fixing unit which includes a flareless joint slidably attached to an outer circumference of the rod-shaped casing and a locking screw to the attachment hole, wherein rod insertion length is adjustable in accordance with mold thickness.

Further, compressed-air supply means may be connected to the gas introduction chamber to enable to supply purge air to the porous filter.

According to the present invention, a measurement sensor for mold inside information capable of detecting gas pressure in a cavity, includes: a rod-shaped casing which is capable of being attached to an attachment hole formed at a mold and opened to the cavity and which is longer than thickness of the mold; a sensor block which is arranged at a base end part of the rod-shaped casing; a porous filter of which top end face is capable of being matched with a mold cavity face as being arranged at a top end of the rod-shaped casing and which is capable of separating gas from melt; an introduction chamber of cavity gas introduced through the porous filter as being arranged at the sensor block; and a gas pressure sensor which detects pressure of the gas introduction chamber as being arranged at the sensor block.

According to the present invention, a measurement sensor for mold inside information capable of detecting gas pressure in a cavity and melt pressure in the cavity, includes: a rod-shaped casing which is capable of being attached to an attachment hole formed at a mold and opened to the cavity and which is longer than thickness of the mold; a sensor block which is arranged at a base end part of the rod-shaped casing; a porous filter of which top end face is capable of being matched with a mold cavity face as being arranged at a top end of the rod-shaped casing and which is capable of separating gas from melt; an introduction chamber of cavity gas introduced through the porous filter as being arranged at the sensor block; a gas pressure sensor which detects pressure of the gas introduction chamber as being arranged at the sensor block; a pressure transmission rod which is inserted into the rod-shaped casing and of which top end face is capable of being matched with the mold cavity face as being movable in the axial center direction; and a pressure sensor which is held at a space against the sensor block as being faced to a rear end of the pressure transmission rod and which is capable of detecting pressure of melt filled into the cavity.

The pressure transmission rod may be configured to be inserted to a center part of the porous filter which is ring-shaped; and a thermocouple is placed in a thin hole which reaches a rod top end part as being formed at a center part of the pressure transmission rod.

### Advantageous Effects of Invention

According to the present invention being used for a pressure-casting machine to cast a product while metal melt which is fed into a plunger sleeve by a specified amount is pressurized and filled into a mold by a plunger, it is possible to monitor the inside of a cavity of the mold. In particular, quality management can be performed by measuring metal pressure at a mold side for detecting as anomalous pressure when a cold flake is caught by a gate and by monitoring pressure drop speed due to solidification shrinkage.

Further, it is possible to control gas entrapment of melt which enters from a gate by managing pressure of gas (mixture gas of air, vapor and the like) of a cavity (a mold of a product part) and vacuum in a vacuum die-casting method. Further, since entering melt in the cavity is solidified instantaneously, temperature of melt can be controlled by measuring mold temperature at that time.

Production sites of die-casting have poor surroundings. Since three sensors are included into a single sensor and a top end of a pin can be easily attached to and detached from a mold face (a back face of a product or the like), excellent operational efficiency is obtained. Further, it is also possible to observe an injection waveform and a pressure waveform in the cavity against a common time axis by appropriately connecting a monitoring device to a pressure measurement portion in the cavity. Owing to integration of a plurality of measurement sensors for measuring pressure of metal melt and gas pressure of gas in the cavity compressed by filling of the metal melt, cost for attaching can be reduced as reducing operational time for attaching to and detaching from the mold.

### BRIEF DESCRIPTION OF DRAWINGS

FIG. 1 is a longitudinal sectional view of a measurement sensor for mold inside information according to a first embodiment.

FIG. 2 is a sectional view of a sensor block body which structures the measurement sensor for mold inside information according to the first embodiment.

FIG. 3 is a partially-sectioned plane view of a sensor block of the measurement sensor for mold inside information according to the first embodiment.

FIG. 4 is a side view of the measurement sensor for mold inside information according to the first embodiment.

FIG. 5 is a schematic sectional view in a state that a measurement rod having the measurement sensor for mold inside information according to the first embodiment attached to a top end thereof is attached to a mold.

FIG. 6 is a sectional view schematically illustrating a structure of a measurement sensor for mold inside information according to a second embodiment.

FIG. 7 is a longitudinal partially-sectioned view illustrating a whole structure of a measurement rod having the measurement sensor for mold inside information of the second embodiment attached to a top end thereof.

FIG. 8 is a partially-removed perspective view of a mold used for a die-cast machine.

FIG. 9 is a sectional view illustrating a state that metal melt is filled into a mold cavity of the present invention.

FIG. 10 is a view indicating metal pressure, gas pressure and mold temperature at the time of pressure-casting in chronological order.

### DESCRIPTION OF EMBODIMENTS

In the following, embodiments of a measurement sensor for mold inside information according to the present invention will be described in detail with reference to the drawings.

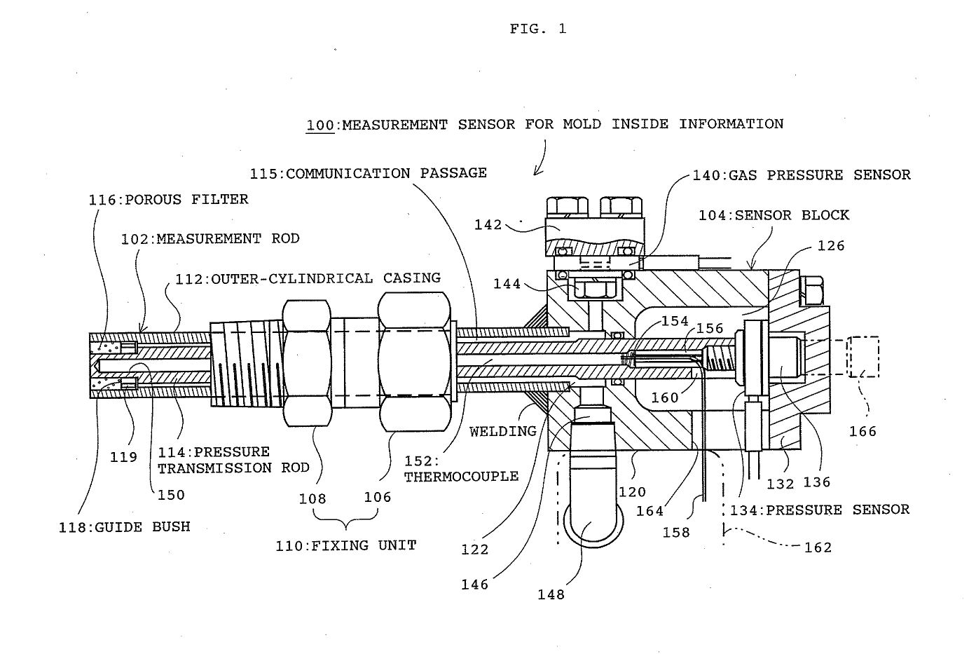

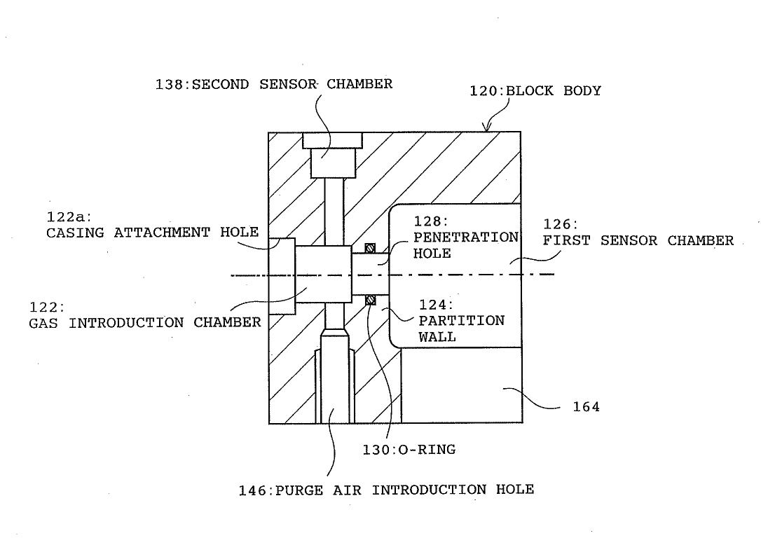

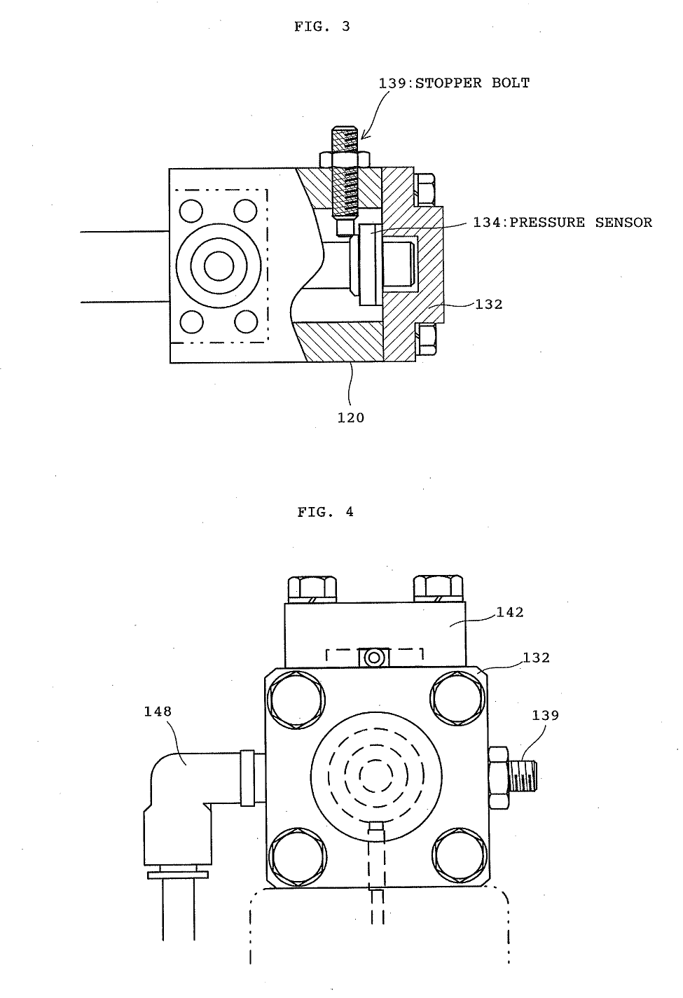

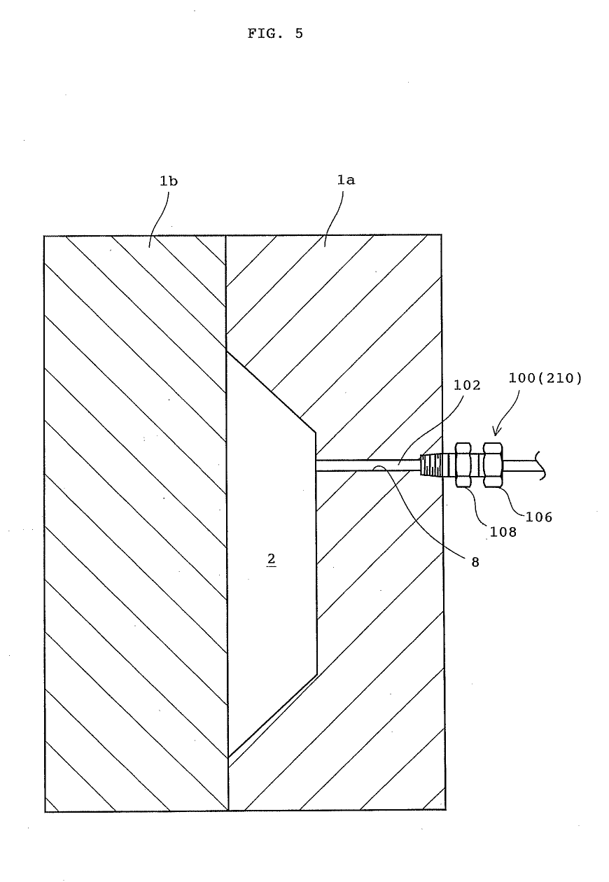

FIGS. 1 to 5 illustrate a measurement sensor 100 for mold inside information according to a first embodiment. FIG. 1 is a longitudinal sectional view of the measurement sensor 100 for mold inside information. FIG. 2 is a sectional view of a sensor block body. FIG. 3 is a partially-sectioned plane view of a sensor block. FIG. 4 is a right side view of FIG. 1. FIG. 5 is a schematic sectional view illustrating an attaching state to a mold.

The measurement sensor 100 for mold inside information according to the first embodiment is capable of being attached to a movable die 1a (or a fixed die 1b) of a mold. Accordingly, as illustrated in FIG. 5, an attachment hole 8 which reaches a cavity 2 from a back face thereof is formed at the movable die 1a. The measurement sensor 100 for mold inside information includes a measurement rod 102 which is inserted and attached to the attachment hole 8 so that a top face thereof is matched with a surface of the cavity 2 and a sensor block 104 which is arranged at a base end of the measurement rod 102 as being located outside the movable die 1a.

To accept thickness of the movable die 1a, a fixing unit 110 which includes a flareless joint 106 and a locking screw 108 is slidably attached to an outer circumferential section at a midpoint of the measurement rod 102. A top end position of the measurement rod 102 is adjusted to be matched with a face of the cavity 2 of the mold and the locking screw 108 is tightened to an attachment hole 14 of the movable die 1a, and then, the flareless joint 106 is rotated to bite into an outer circumferential face of the measurement rod 102. In this manner, the measurement rod 102 is fixed to a specified position.

As illustrated in FIG. 1, the measurement rod 102 includes an outer-cylindrical casing 112 and a pressure transmission rod 114 which is arranged at a center part thereof along the axial center direction. The pressure transmission rod 114 is a columnar body of which outer diameter is smaller than an inner diameter of the outer-cylindrical casing 112 to form a communication passage 115 between the outer-cylindrical casing 112 and the pressure transmission rod 114. The outer-cylindrical casing 112 is formed to have a slightly-enlarged inner diameter at the top end part of the measurement rod 102, and the top end of the pressure transmission rod 114 is formed to have a cross-section being smaller than a rod body section. Between the above, a ring-shaped porous filter 116 and a guide bush 118 are sequentially attached side by side from the rod top end side. Similarly to the first embodiment, the porous filter 116 is formed of material such as alumina ceramics and carbon nanotube having fine holes to which metal melt of aluminum or the like does not enter. Further, the guide bush 118 is formed of hard ceramic such as silicon nitride and zirconia having low heat conductivity. The guide bush 118 positionally holds the top end part of the pressure transmission rod 114 at the center part of the outer-cylindrical casing 112 while slidably holding in the axial direction as a slide bearing. Accordingly, the top end face of the measurement rod 102 can structure a part of the mold cavity 2 by being attached to the movable die 1a, as concentrically arranging an end face of the outer-cylindrical casing 112 at the outermost circumference, an end face of the pressure transmission rod 114 at the center part, and the porous filter 116 therebetween. Further, a communication hole 119 which provides communication between the communication passage 115 and the porous filter 116 side is formed at the guide bush 118. With the above, gas in the cavity 2 can be introduced to the communication passage 115 as being separated from melt at the filter 116.

Here, the base part of the measurement rod 102 is attached to the sensor block 104. The sensor block 104 includes a rectangular block body 120 as illustrated in FIG. 2. A gas introduction chamber 122 is formed to be opened to one face of the block body 120 and a first sensor chamber 126 is formed in line on the same axial center to be opened to an opposite face as sandwiching a partition wall 124. A penetration hole 128 which provides communication between the gas introduction chamber 122 and the first sensor chamber 126 is formed at the partition wall 124.

The measurement rod 102 is attached to the abovementioned sensor block 104. The base end part of the outer-cylindrical casing 112 is attached to a casing attachment hole 122a which is formed to be opened at an inlet opening of the gas introduction chamber 122 and is joined with welding at a corner section between the casing outer circumference and the block body 120.

A base end of the pressure transmission rod 114 of the measurement rod 102 is formed longer than the outer-cylindrical casing 112. The base end part is inserted through the penetration hole 128 and is extended to the first sensor chamber 26. The penetration hole 128 bearing-supports the pressure transmission rod 114 as sealing clearance against the pressure transmission rod 114 with an O-ring 130. Accordingly, the pressure transmission rod 114 is movable at the inside of the outer-cylindrical casing 112 in the axial center direction as being supported at two points by the guide bush 118 which is arranged at an inner circumference of the top end part of the outer-cylindrical casing 112 and the penetration hole 128 which is arranged at the partition wall 124 of the sensor block 104. Owing to that the top end of the pressure transmission rod 114 receives pressure, the rod is pressed in the axial direction and is moved toward the opening side of the first sensor chamber 126 of the sensor block 104.

A pressure sensor 134 formed into a doughnut-ring shape is attached to an end face of the base end part of the pressure transmission rod 114 in a state that a pre-load is applied by a center fixing bolt 136. Meanwhile, a block cover 132 which covers the opening of the first sensor chamber 126 is attached to the sensor block 104 as being opposed to the base end face of the pressure transmission rod 114 so that the pressure sensor 134 is attached as being sandwiched with the pressure transmission rod 114. Accordingly, force received by the top end of the pressure transmission rod 114 is transmitted to the pressure sensor 134 having an inner face part of the block cover 132 as a support face, so that the load thereof can be detected. In the embodiment, the pressure sensor 134 is formed with a piezoelectric type load detection sensor using a ceramic piezoelectric element. With the above, metal pressure of melt filled into the cavity 2 can be measured.

Since the pressure transmission rod 114 being movable in the axial direction is stopped by the block cover 132 when pressure is received at the top end, there is substantially no positional movement. However, in a state of no pressure, there is a fear that the pressure transmission rod 114 moves spontaneously. To prevent the above, a stopper bolt 139 extended into the first sensor chamber 126 from an outer face of the sensor block 104 is attached as illustrated in FIGS. 3 and 4. The stopper bolt 139 is attached so that the bolt top end is abutted to an outer edge at a front face part of the positioning-performed pressure sensor 134 to sandwich the pressure sensor 134 with the block cover 132.

Meanwhile, the communication passage 115 formed between the outer-cylindrical casing 112 and the pressure detection rod 114 of the measurement rod 102 is communicated with the gas introduction chamber 122 at the inside of the sensor block 104. As illustrated in FIGS. 1 and 2, a second sensor chamber 138 communicated with the gas introduction chamber 122 is formed to be opened to a block outer circumferential face. A gas pressure sensor 140 is arranged at the opening portion of the second sensor chamber 138 to hermetically seal the opening portion and the sensor outer face is held by a holding block 142. The holding block 142 is fixed to the sensor block 104 with bolting. The gas pressure sensor 140 shaped like a doughnut-ring adopts a piezoelectric type load detection sensor using a ceramic piezoelectric element similarly to the abovementioned pressure sensor 134 and is fixed to the holding block 142 in a state that a pre-load is applied by a sensor fixing bolt 144. With the above, pressure gas introduced to the porous gas introduction chamber 122 at the top end of the measurement rod 102 is exerted to the whole face of the gas pressure sensor 140 faced to the opening portion of the second sensor chamber 138. Accordingly, gas in the cavity 2 introduced through the porous filter 116 at the top end side of the measurement rod 102 is introduced to the second sensor chamber 138 from the gas introduction chamber 122 via the communication passage 115 and pressure thereof can be measured by the gas pressure sensor 140.

By the way, a purge air introduction hole 146 is opened to the gas introduction chamber 122. A compressed-air supply pipe 148 is connected to the purge air introduction hole 146, so that compressed-air can be supplied from a compressed-air source (not illustrated) outside a system. With the above, clogging of a filter 44 can be checked as flowing compressed-air to the abovementioned porous filter 116 side via the gas introduction chamber 122. It is checked whether or not the porous filter 116 is normal for each shot as detecting presence or absence of remaining pressure with the gas pressure sensor 140 after a specified time after stopping purge air in a state without a product being in a molding cycle. Since air communication is necessarily blocked during molding, it is only required to arrange a check valve (not illustrated) at a passage up to the purge air introduction hole 146.

Further, a thin hole 150 is formed at an axial center part of the abovementioned pressure transmission rod 114. The thin hole 150 is formed to reach the vicinity of the top end of the pressure transmission rod 114 and to have depth leaving slight thickness to be capable of detecting metal pressure with the rod. A sheath type thermocouple 152 is filled into the thin hole 150. The sheath type thermocouple 152 may adopt a general type in which isolation material is filled into a sheath pipe and wires are embedded thereto. With respect to the sheath type thermocouple 152, a detection end is oriented to the top end part side of the pressure transmission rod 114 and a base end of the sheath pipe is pressed by the top end part of the sensor fixing bolt 136. To maintain pressing force, a holddown spring 154 and a holddown piece 156 are stored in the thin hole 150 between the bolt top end of the sensor fixing bolt 136 and an end part of the sheath pipe of the sheath type thermocouple 152. Accordingly, at the same time when the pressure sensor 134 is fixed by the sensor fixing bolt 136, the detection end of the thermocouple 152 is held at the top end position of the pressure transmission rod 114 as the holddown piece 156 being pressed and the sheath pipe being pressed with predetermined force by the holddown spring 154. A lead wire 158 of the sheath type thermocouple 152 is led to the outside of the block via a cutout groove 160 which is formed at the base end of the pressure transmission rod 114.

In the embodiment, a terminal box 162 is accompanied with the sensor block 104. A variety of lead wires of the pressure sensor 134, the gas pressure sensor 140 and the sheath type thermocouple 152 are introduced thereto. The respective sensors and the like are connected to measurement equipment via the terminal box 162, so that predetermined measurement data can be output and, if required, displayed on display means. Here, a lead passage 164 reaching the first sensor chamber 126 for leading the lead wire of the pressure sensor 134 is formed at the sensor block 104.

In the embodiment, according to the measurement sensor 100 for mold inside information structured as described above, the measurement rod 102 is inserted to the attachment hole 14 which is formed at the movable die 1a and is fixed at a specified position by the fixing unit 110 so that the top end face thereof is flush with the cavity 3 in a state that the mold is opened. In injecting operation after the above attaching is completed, melt is filled into the cavity 2 and metal pressure of the melt is exerted to the top end of the measurement rod 102 which is faced to the cavity 2. Subsequently, the pressure transmission rod 114 is pressed, so that the force thereof is detected by the pressure sensor 134. Simultaneously, gas in the cavity is introduced to the gas introduction chamber 122 though the porous filter 116 via the communication passage 115 and the gas pressure thereof is detected by the gas pressure sensor 140. Further, the sheath type thermocouple 152 arranged at the top end part of the pressure transmission rod 114 detects melt temperature. The data of the above is measured by measurement equipment (not illustrated) in chronological order, so that metal temperature, gas pressure in the mold and metal temperature are measured as illustrated in FIG. 10.

When mold lubricant is applied to a cavity surface after one shot of injection molding is completed and a product is removed from an opened mold, compressed-air blowing is performed as purge air from the compressed-air supply pipe 148 to the porous filter 116 via the gas introduction chamber 122 and the communication passage 115. Accordingly, clogging of the filter 116 is prevented while preventing the mold lubricant from adhering to the filter 116. When detection pressure of the gas pressure sensor 140 is increased to be higher than atmospheric pressure or pressure including airflow resistance at the time of air purging, it is determined that the filter 116 is clogged with melt and replacement operation of the filter 116 may be performed.

Here, replacement of the porous filter 116 is performed as follows. First, the stopper bolt 139 (see FIG. 3) of the pressure sensor 134 is released and engagement with the sensor is released. Subsequently, the sensor fixing bolt 144 is pushed by a push bolt 166 (imaginary line at the right end in FIG. 4) from an outer face of the block cover 132 and is moved frontward. Accordingly, the pressure transmission rod 114 is moved to push the guide bush 118 and the porous filter 116 is pushed out from the top end. After performing removal of the above and filter change, a new porous filter 116 is pushed along with the pressure transmission rod 114 to be stored in the outer-cylindrical casing 112. When the pressure sensor 134 is moved until being abutted to the block cover 132, the stopper bolt 139 is turned and the bolt top end is engaged with the front face outer edge of the pressure sensor 134. In this manner, the replacement operation is completed.

Compared to a case that only indirect information can be obtained from a mold surface or a machine as in the related art, according to the measurement sensor 100 for mold inside information of the first embodiment as described above, owing to direct information of melt which is filled in the cavity 2, it is possible to prevent defectives from being fed to a subsequent process while the direct information is used for performing quality determination of casting products. Accordingly, remarkable improvement of yield can be obtained.

In the present embodiment, owing to combining integration of a sensor to measure pressure of metal melt, a sensor to measure temperature of melt and a sensor to measure pressure of gas in a cavity compressed with melt filling, the measurement sensor 100 for mold inside information can be easily attached to and detached from a mold face with high operability. Further, when a monitoring device is appropriately connected to a pressure measurement portion in the cavity 2 by using the trinity measurement sensor 100 for mold inside information of metal pressure, gas pressure and metal temperature, it is possible to observe an injection pressure waveform and a gas pressure waveform in the cavity 2 against a common time axis along with metal temperature information.

Detection of metal pressure, gas pressure and metal temperature is performed at a face of the cavity 2 of the mold movable die 1a. Here, since the sensor block 104 including the sensors and the like is located outside of the fixing unit 110, that is, at a position being apart from the mold, thermal influence to the sensors and the like can be prevented. Even if length of the measurement rod 102 is arbitrarily adjusted, sensing operation is not influenced thereby.

Further, the pressure sensor 134 and the gas pressure sensor 140 being piezoelectric type load detection sensors respectively using a ceramic piezoelectric element are air-cooled as being attached in an open state as not being placed in a hermetically-sealed space. In the light of the above, thermal influence can be avoided as well.

The metal temperature measurement is performed at the top end of the pressure transmission rod 114. Here, the pressure transmission rod 114 itself is not structured to be directly contacted to a mold as being thermally disconnected from the outer-cylindrical casing 112 by the porous filter 116, the adiathermic guide bush 118 and the communication passage 115. Therefore, measurement of the metal temperature can be performed without being influenced by mold temperature. Accordingly, metal temperature detection can be performed at high accuracy.

The abovementioned embodiments adopt a structural example of a combining type melt sensor. However, it is also possible to structure to separately perform gas pressure detection, metal pressure detection and metal temperature detection in the cavity. Further, it is also possible to structure to combine two kinds of detection functions.

Further, the above embodiment is described with an example as being applied to a die-cast machine. However, it is also possible to be applied to a mold of a resin injection molding machine. In this case as well, it is naturally possible to measure cavity gas pressure, resin pressure and resin temperature at the time of injection.

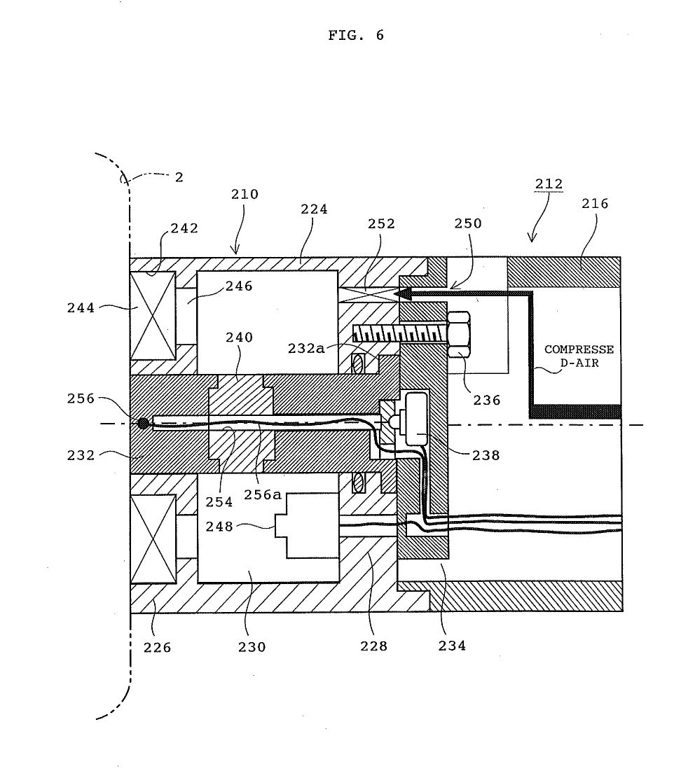

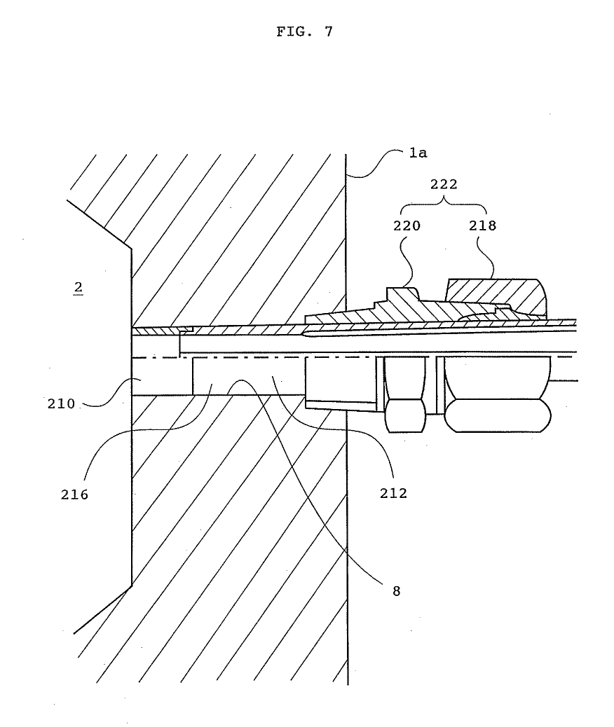

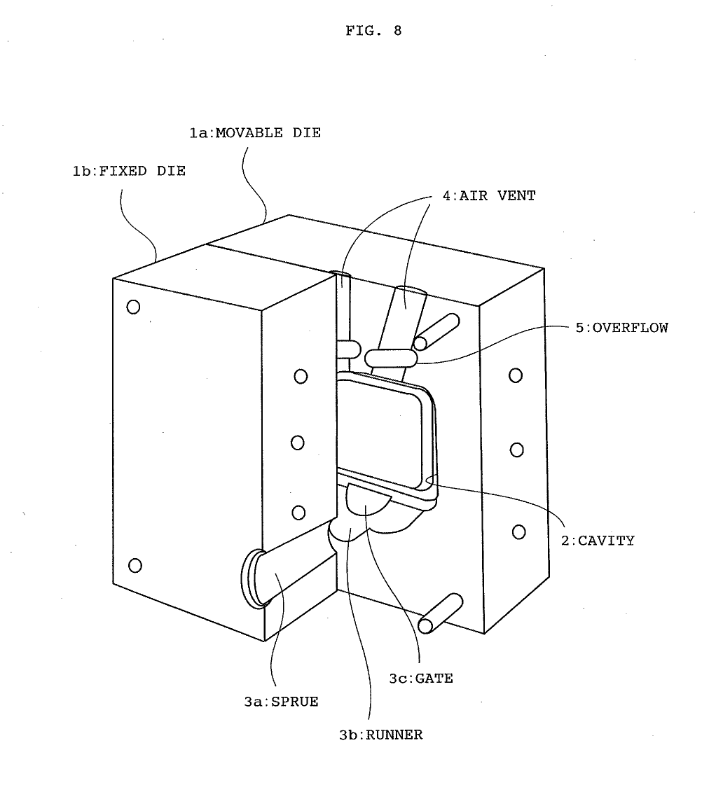

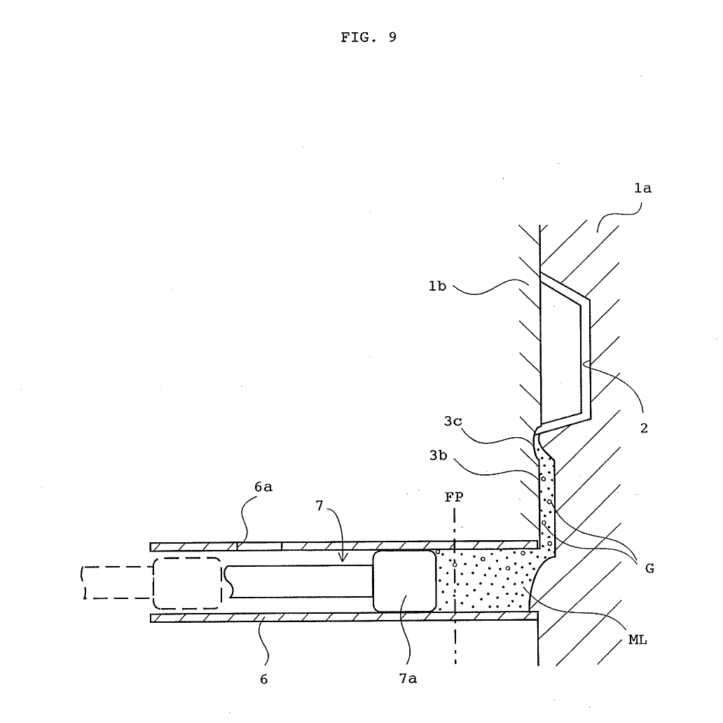

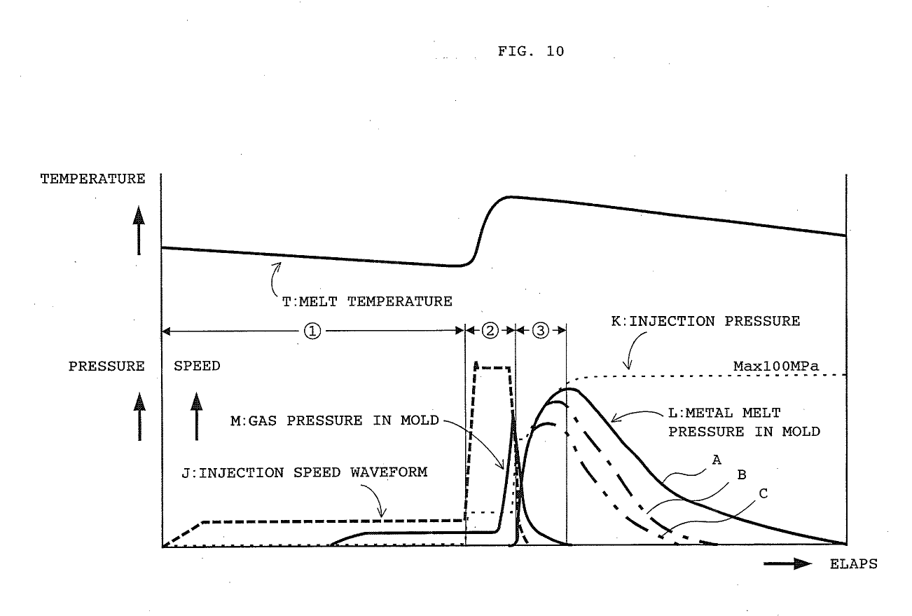

Next, a measurement sensor 210 for mold inside information according to a second embodiment is illustrated in FIGS. 6 and 7. The embodiment adopts a structure in which the measurement sensor 210 for mold inside information including a sensor portion is attached to a top end of a measurement rod in small chip form.

FIGS. 6 and 7 illustrate the measurement sensor 210 for mold inside information (FIG. 6) according to the second embodiment in which the present invention is applied to a die-cast machine and a measurement rod 212 (FIG. 7) to which the above is attached. Similarly to the abovementioned first embodiment, the measurement sensor 210 for mold inside information measures variation of metal pressure, gas pressure and temperature in a cavity 2.

The rod type measurement rod 212 is attached to a movable die 1a. As illustrated in FIG. 7, an attachment hole 8 which reaches the cavity 2 from a back face thereof is formed at the movable die 1a (or a fixed die 1b). The measurement rod 212 is attached as being inserted from the die back face so that the rod top end is matched with a cavity face. To accept thickness of the movable die 1a, a fixing unit 222 which includes a flareless joint 218 and a locking screw 220 is slidably attached to an outer circumferential section at a midpoint of a rod-shaped casing 216 of the measurement rod 212. A rod top end position is adjusted to be matched with the face of the cavity 2 of the mold and the locking screw 220 is tightened to a female screw portion which is formed at an inlet portion of the attachment hole 8 of the die 1a, and then, the flareless joint 218 is rotated to bite into the casing 216. In this manner, the measurement rod 212 is fixed to a specified position.

The measurement sensor 210 for mold inside information according to the embodiment is arranged at the top end of the measurement rod 212. Details of the sensor 210 are illustrated in a sectional view of FIG. 6. The measurement sensor 210 for mold inside information includes a cylindrical case 224 which has the same outer diameter as the rod-shaped casing 216 and which is concentrically attached as being screwed to the top end part of the rod-shaped casing 216. At the inside thereof, the sensor 210 includes a metal pressure measurement portion, a gas pressure measurement portion and a melt temperature measurement portion.

The metal pressure measurement portion is structured as follows. The cylindrical case 224 includes an end plate portion 226 being flush with the cavity 2, a partition plate portion 228 being at a rear side, and a space portion (gas introduction chamber) 230 being formed at an intermediate section of the both. A pressure transmission rod 232 which is axially supported by the end plate portion 226 and the partition plate portion 228 is attached to a center part of the cylindrical case 224 along the axial center direction as being slidable in the axial direction to be capable of transmitting pressure received from melt ML filled in the cavity 2 to the rear side. A flange 232a is arranged at a rear end part of the pressure transmission rod 232 and the flange 232a is fitted to a concave portion which is formed at the partition plate portion 228. A holding cover 234 is fixed to a back face (opposite side to the cavity 2) of the partition plate portion 228 with a bolt 236 to cover the whole back face. A load cell 238 is attached to the holding cover 234 at a position faced to the flange 232a of the pressure transmission rod 232. Accordingly, the pressure transmission rod 232 is capable of measuring metal pressure which is directly received from the melt ML.

Instead of the load cell 238, it is also possible to adopt a piezoelectric type pressure sensor (heatproof temperature: 300 degrees, measurement melt temperature: 850 degrees or lower, maximum measurement pressure: 200 MPa). Material having a piezoelectric effect enables to place a sensor detection portion at a position being closer to melt also from a structural viewpoint and causes expectation of smaller error factors compared to indirect measurement. By using such a sensor, state variation of melt can be acknowledged from pressure transmission of the melt during the time of being filled, so that pressure holding time and the like can be evaluated.

Here, it is also possible to protect the measurement portion side with heat insulation by interposing a heat-insulating ceramic member 240 at a midpoint of the pressure transmission rod 232 to insulate heat from the melt ML.

Next, the gas pressure measurement portion is structured as follows. A circular concave portion 242 is formed at a top end face of the end plate portion 226 to surround a periphery of the pressure transmission rod 232. A ring-shaped porous filter 244 which blocks liquid phase material such as aluminum melt but allows gas to pass through is arranged at the circular concave portion 242. For example, the filter 244 is formed of material such as alumina ceramics and carbon nanotube having fine holes to which metal melt of aluminum or the like does not enter.

Further, a communication passage 246 which is communicated with the space portion 230 of the cylindrical case 224 is formed at a bottom plate section of the circular concave portion 242 to which the filter 244 is attached. Accordingly, gas introduced from the cavity 2 through the filter 244 is introduced to the space portion 230. A gas pressure sensor 248 is attached to the space portion 230. In the embodiment, the gas pressure sensor 248 is fixed to a plate face of the partition plate portion 228. Thus, the gas obtained through gas-liquid separation at the filter 244 is introduced to the space portion 230 and pressure in the space portion 230 can be detected as the gas pressure.

By the way, a purge air introduction hole 250 which is communicated with the rod-shaped casing 216 is formed at the partition plate portion 228 which forms the space portion 230 and the holding cover 234 which is joined thereto. The purge air introduction hole 250 is connected to a compressed-air source (not illustrated) outside a system. It is checked whether or not the filter 244 is normal for each shot as detecting pressure with the gas pressure sensor 248, while flowing air of which pressure and flow rate are controlled in a state without having a product under the cycle to check clogging of the filter 244. Since air communication is necessarily blocked during molding, a check valve 252 is arranged at the purge air introduction hole 250.

Further, the structure of measuring metal temperature is as follows. A thin hole 254 is formed at an axial center part of the pressure transmission rod 232. The thin hole 254 is formed to reach the vicinity of the top end of the pressure transmission rod 232 and to have depth leaving slight thickness to be capable of detecting metal pressure with the rod. A thermocouple 256 is attached to the thin hole 254 to detect melt temperature. The thin hole 254 is used as a lead passage for a lead wire 256a of the thermocouple 256.

Here, lead wires of the load cell 238, the gas pressure sensor 248 and the thermocouple 256 are connected to measurement equipment outside a system via passages formed at the partition plate portion 228 and the holding cover 234 and the rod-shaped casing 216.

In the embodiment, according to the measurement sensor 210 for mold inside information structured as described above, the measurement rod 212 is inserted to the attachment hole 8 which is formed at the movable die 1a and is fixed at a specified position by the fixing unit 222 so that the top end face of the measurement sensor 210 for mold inside information is flush with the cavity 2 in a state that the mold is opened. In injection operation after the above attaching is completed, melt is filled into the cavity 2 and metal pressure of the melt is exerted to the top end of the measurement sensor 210 for mold inside information which is faced to the cavity 2. Subsequently, the pressure transmission rod 232 is pressed, so that the force thereof is detected by the load cell 238. Simultaneously, gas in the cavity is introduced to the space portion 230 through the filter 244 and the gas pressure thereof is detected. Further, the thermocouple 256 arranged at the top end part of the pressure transmission rod 232 detects melt temperature. The data of the above is measured by measurement equipment (not illustrated) in chronological order, so that metal temperature, gas pressure in the mold and metal temperature are measured as illustrated in FIG. 10.

When mold lubricant is applied to a cavity surface after one shot of injection molding is completed and a product is removed from an opened mold, compressed-air flowing is performed on the filter 244 via the space portion 230 as purge air. Accordingly, clogging of the filter 244 is prevented while preventing the mold lubricant from adhering to the filter 244. When detection pressure of the gas pressure sensor 248 is increased to be higher than atmospheric pressure or pressure including airflow resistance at the time of air purging, it is determined that the filter 44 is clogged with melt and replacement operation of the filter 244 may be performed.

Similarly to a case of the first embodiment, according to the measurement sensor 210 for mold inside information of the second embodiment, it is possible to directly measure cavity gas pressure, metal pressure and metal temperature of melt filled in the cavity 2. Therefore, direct cavity inside information can be obtained and can be used for quality determination of casting products. Accordingly, it is possible to prevent detectives from being fed to a subsequent process and remarkable improvement of yield can be obtained.

Further, owing to combining integration of a sensor to measure pressure of metal melt, a sensor to measure temperature of melt and a sensor to measure pressure of gas in a cavity compressed with melt filling, the measurement sensor 210 for mold inside information can be easily attached to and detached from a mold face with high operability. Further, when a monitoring device is appropriately connected to a pressure measurement portion in the cavity 2 by using the trinity measurement sensor 210 for mold inside information of metal pressure, gas pressure and metal temperature, it is possible to observe an injection pressure waveform and a gas pressure waveform in the cavity 2 against a common time axis along with metal temperature information.

Especially, in the second embodiment, since the measurement sensor 210 for mold inside information is arranged at the top end of the measurement rod 212 in small chip form, handling thereof is easy and replacement when damaged can be easily performed.

Similarly to the first embodiment, in the second embodiment, it is also possible to structure to separately measure metal pressure, gas pressure and metal temperature or to structure to perform measurement with combination of two kinds.

By the way, pass/fail criteria are strictly defined in JIS as follows.

### A. Determination of Metal Pressure

1. Maximum value being X % or higher against machine pressure

(Example) Pressure raised to be 80% or higher in metal conversion

2. Being Y % or higher after t seconds

(Example) Pressure being 20% or higher after 0.1 second from filling completion

### B. Gas Pressure (for Atmospheric Pressure Die-Casting)

1. Gas pressure being V Pa or lower

(Example) Maximum value of gas pressure being 50 Pa or lower

2. Integrated value of gas pressure being Z cm2 or smaller

(Example) Integrated value of gas pressure as gas volume being 80% or lower of cavity volume

### C. Gas Pressure (for Vacuum Die-Casting)

1. Vacuum pressure being W Pa or higher

(Example) Maximum value of vacuum being −30 Pa or lower

2. Integrated value of vacuum pressure being V cm2 or larger

### D. Mold Temperature

Mold temperature being between upper limit and lower limit inclusive of temperature amplitude

In the present embodiment, since measurement for the above determination criteria can be performed directly from melt, reliable measurement data can be obtained.

### INDUSTRIAL APPLICABILITY

The present invention achieves remarkable contribution to quality stabilization as providing a sensor capable of performing product quality determination while monitoring the inside of mold cavity at the time of molding with a die-cast machine or a resin injection machine.

### REFERENCE SIGNS LIST

1a Movable die
1b Fixed die
2 Cavity
3a Sprue
3b Runner
3c Gate
4 Air vent
5 Overflow
6 Plunger sleeve
6a Pouring port
7 Plunger
7a Plunger tip
100 Measurement sensor for mold inside information
102 Measurement rod
104 Sensor block
106 Flareless joint
108 Locking screw
110 Fixing unit
112 Outer-cylindrical casing
114 Pressure transmission rod
115 Communication passage
116 Porous filter
118 Guide bush
119 Communication hole
120 Block body
122 Gas introduction chamber
122a Casing attachment hole
124 Partition wall
126 First sensor chamber
128 Penetration hole
130 O-ring
132 Block cover
134 Pressure sensor
136 Sensor fixing bolt
138 Second sensor chamber
139 Stopper bolt
140 Gas pressure sensor
142 Holding block
144 Sensor fixing bolt
146 Purge air introduction hole
148 Compressed-air supply pipe
150 Thin hole
152 Sheath type thermocouple
154 Holddown spring
156 Holddown piece
158 Lead wire
160 Cutout groove
162 Terminal box
164 Lead passage
166 Push bolt
210 Measurement sensor for mold inside information
212 Measurement rod
214 Attachment hole
216 Rod-shaped casing
218 Flareless joint
220 Locking screw
222 Fixing unit
224 Cylindrical case
226 End plate portion
228 Partition plate portion
230 Space portion
232 Pressure transmission rod
232a Flange
234 Holding cover
236 Bolt
238 Load cell
240 Heat-insulating ceramic member
242 Circular concave portion
244 Filter
246 Communication passage
248 Gas pressure sensor
250 Purge air introduction hole
252 Check valve
254 Thin hole
256 Thermocouple

1. A measurement sensor for mold inside information capable of detecting gas pressure in a cavity, comprising:
a rod-shaped casing which is capable of being attached to an attachment hole formed at a mold and opened to the cavity;
a porous filter of which top end face is capable of being matched with a mold cavity face as being arranged at a top end of the rod-shaped casing and which is capable of separating gas from melt;
an introduction chamber of cavity gas introduced through the porous filter as being arranged behind the porous filter; and
a gas pressure sensor which detects pressure of the gas introduction chamber.

2. A measurement sensor for mold inside information capable of detecting gas pressure in a cavity and melt pressure in the cavity, comprising:
a rod-shaped casing which is capable of being attached to an attachment hole formed at a mold and opened to the cavity;
a porous filter of which top end face is capable of being matched with a mold cavity face as being arranged at a top end of the rod-shaped casing and which is capable of separating gas from melt;
an introduction chamber of cavity gas introduced through the porous filter as being arranged behind the porous filter;
a gas pressure sensor which detects pressure of the gas introduction chamber;
a pressure transmission rod which is inserted into the rod-shaped casing and of which top end face is capable of being matched with the mold cavity face as being movable in the axial center direction; and
a pressure sensor which is fixed and held as being faced to a rear end of the pressure transmission rod and which is capable of detecting pressure of melt filled into the cavity.

3. A measurement sensor for mold inside information capable of detecting gas pressure in a cavity and melt temperature in the cavity, comprising:
a rod-shaped casing which is capable of being attached to an attachment hole formed at a mold and opened to the cavity;
a porous filter of which top end face is capable of being matched with a mold cavity face as being arranged at a top end of the rod-shaped casing and which is capable of separating gas from melt;
an introduction chamber of cavity gas introduced through the porous filter as being arranged behind the porous filter;
a gas pressure sensor which detects pressure of the gas introduction chamber;
a rod which is inserted into the rod-shaped casing and of which top end face is capable of being matched with the mold cavity face as being movable in the axial center direction; and
a temperature sensor which is attached to a thin hole formed at a center part of the rod and which includes a thermocouple having a detection end at a rod top end part side of the thin hole.

4. A measurement sensor for mold inside information capable of detecting gas pressure in a cavity, melt pressure in the cavity and melt temperature in the cavity, comprising:
a rod-shaped casing which is capable of being attached to an attachment hole formed at a mold and opened to the cavity;
a porous filter of which top end face is capable of being matched with a mold cavity face as being arranged at a top end of the rod-shaped casing and which is capable of separating gas from melt;
an introduction chamber of cavity gas introduced through the porous filter as being arranged behind the porous filter;
a gas pressure sensor which detects pressure of the gas introduction chamber;
a pressure transmission rod which is inserted into the rod-shaped casing and of which top end face is capable of being matched with the mold cavity face as being movable in the axial center direction;
a pressure sensor which is fixed and held as being faced to a rear end of the pressure transmission rod and which is capable of detecting pressure of melt filled into the cavity; and
a temperature sensor which is attached to a thin hole formed at a center part of the pressure transmission rod and which includes a thermocouple having a detection end at a rod top end part side of the thin hole.

5. The measurement sensor for mold inside information according to claim 1, further comprising a fixing unit which includes a flareless joint slidably attached to an outer circumference of the rod-shaped casing and a locking screw to the attachment hole,
wherein rod insertion length is adjustable in accordance with mold thickness.

6. The measurement sensor for mold inside information according to claim 1,
wherein compressed-air supply means is connected to the gas introduction chamber to enable to supply purge air to the porous filter.

7. A measurement sensor for mold inside information capable of detecting gas pressure in a cavity, comprising:
a rod-shaped casing which is capable of being attached to an attachment hole formed at a mold and opened to the cavity and which is longer than thickness of the mold;
a sensor block which is arranged at a base end part of the rod-shaped casing;
a porous filter of which top end face is capable of being matched with a mold cavity face as being arranged at a top end of the rod-shaped casing and which is capable of separating gas from melt;
an introduction chamber of cavity gas introduced through the porous filter as being arranged at the sensor block; and
a gas pressure sensor which detects pressure of the gas introduction chamber as being arranged at the sensor block.

8. A measurement sensor for mold inside information capable of detecting gas pressure in a cavity and melt pressure in the cavity, comprising:
a rod-shaped casing which is capable of being attached to an attachment hole formed at a mold and opened to the cavity and which is longer than thickness of the mold;
a sensor block which is arranged at a base end part of the rod-shaped casing;
a porous filter of which top end face is capable of being matched with a mold cavity face as being arranged at a top end of the rod-shaped casing and which is capable of separating gas from melt;
an introduction chamber of cavity gas introduced through the porous filter as being arranged at the sensor block;
a gas pressure sensor which detects pressure of the gas introduction chamber as being arranged at the sensor block;
a pressure transmission rod which is inserted into the rod-shaped casing and of which top end face is capable of being matched with the mold cavity face as being movable in the axial center direction; and
a pressure sensor which is held at a space against the sensor block as being faced to a rear end of the pressure transmission rod and which is capable of detecting pressure of melt filled into the cavity.

9. The measurement sensor for mold inside information according to claim 7,
wherein the pressure transmission rod is configured to be inserted to a center part of the porous filter which is ring-shaped; and
a thermocouple is placed in a thin hole which reaches a rod top end part as being formed at a center part of the pressure transmission rod.

10. The measurement sensor for mold inside information according to claim 2, further comprising a fixing unit which includes a flareless joint slidably attached to an outer circumference of the rod-shaped casing and a locking screw to the attachment hole,
wherein rod insertion length is adjustable in accordance with mold thickness.

11. The measurement sensor for mold inside information according to claim 3, further comprising a fixing unit which includes a flareless joint slidably attached to an outer circumference of the rod-shaped casing and a locking screw to the attachment hole,
wherein rod insertion length is adjustable in accordance with mold thickness.

12. The measurement sensor for mold inside information according to claim 4, further comprising a fixing unit which includes a flareless joint slidably attached to an outer circumference of the rod-shaped casing and a locking screw to the attachment hole,
wherein rod insertion length is adjustable in accordance with mold thickness.

13. The measurement sensor for mold inside information according to claim 2,
wherein compressed-air supply means is connected to the gas introduction chamber to enable to supply purge air to the porous filter.

14. The measurement sensor for mold inside information according to claim 3,
wherein compressed-air supply means is connected to the gas introduction chamber to enable to supply purge air to the porous filter.

15. The measurement sensor for mold inside information according to claim 4,
wherein compressed-air supply means is connected to the gas introduction chamber to enable to supply purge air to the porous filter.

16. The measurement sensor for mold inside information according to claim 8,
wherein the pressure transmission rod is configured to be inserted to a center part of the porous filter which is ring-shaped; and
a thermocouple is placed in a thin hole which reaches a rod top end part as being formed at a center part of the pressure transmission rod.
